(19) United States
(12) Patent Application Publication
(10) Pub. No.: US 2005/0071024 A1
(43) Pub. Date: Mar. 31, 2005

(54) Tournament game system

(76) Inventor: Robert Henshaw, Henderson, NV (US)

Correspondence Address: IAN F. BURNS & ASSOCIATES, 1575 DELUCCHI LANE, SUITE 222, RENO, NV, 89502, US

(21) Appl. No.: 10/951,536

(22) Filed: Sep. 27, 2004

Related U.S. Application Data
(60) Provisional application No. 60/506,902, filed on Sep. 25, 2003.

(51) Int. Cl. G06F 19/00; G06F 17/00

(52) U.S. Cl. 700/91

(57) ABSTRACT

One embodiment of a game tournament comprising of at one least primary game and at least one secondary game. The primary game may comprise a set of playing symbols, a set of a predetermined number of playing symbols, and a random symbol generator. The secondary game may comprise of set of tournament values, which are essentially paired with the set of playing symbols, ranked tournament game prizes and a player interface device bearing a plurality of playing symbols. A ranked tournament prize may be awarded to a player when there is a match up of one or more playing symbols from the plurality of playing symbols and the set of a predetermined number of playing symbols and a match between the tournament game prize and the rank of the player within the tournament. The player's ranking being generally based on the sum of the tournament values of the matched up playing symbols.

### CROSS REFERENCE TO RELATED APPLICATIONS

This application refers to and incorporates by reference the U.S. provisional patent application with Ser. No. 60/506,902.

### FIELD OF THE INVENTION

The present invention relates to lotto types of games of chance, which are typified by such games like Bingo and Keno. More particularly, this invention applies to situations where such types of games are played in a tournament.

### BACKGROUND

Lotto-type games, such as Keno, Bingo and others, are essentially well known and popular games of chance with worldwide appeal. However, the growth in the popularity of slot machines has essentially begun to displace lotto-type game, such as Keno, in many gaming establishments. It is generally believed that the original draw of lotto type games was the ability to offer large jackpots or prizes. However, slot machines, which originally had small payouts, now offer large prizes. Many casinos have reduced their Keno operations to the point of removing their Keno salons to make room for slot machines.

In an attempt to essentially reinvigorate the gaming public's enthusiasm for lotto type games, some gaming establishments in Laughlin, Nev. and other gaming jurisdictions have generally begun to apply a tournament type of play to the lotto-type games such as Keno. Here a player can generally play a series of Keno games with the hopes of winning a progressive jackpot(s). Other attempts have also included combining a lotto-type play with slot machines.

Even with these types of approach, there still is a need to develop additional gaming elements for lotto-type games to increase their popularity, draw, and ability to compete with slot machine gaming. This need could encompass a further development of a tournament style of play wherein a tournament game with a separate system of awards and prizes, including progressive or cumulative jackpot payouts could be run in conjunction with lotto-type games and could use various gaming elements of the lotto-type games.

### SUMMARY OF ONE EMBODIMENT OF THE INVENTION

Advantages of One or More Embodiments of the Present Invention

The various embodiments of the present invention may, but do not necessarily, achieve one or more of the following advantages:
the ability to form tournaments using lotto-style games;
provide lotto-style game players with an opportunity to win large and progressive payouts;
provide competitive tournaments with ranked prize payouts;
provide a tournament system that is an alternative to slot machine tournaments;
the ability to build sales, customer traffic, customer loyalty in gaming establishments;
the ability to use a gaming tournament for the gaming establishment's own promotions and special events;
the ability to provide theme-based gaming to increase interest and participation of the gaming public in lotto-style games; and
the ability to maintain a gaming diversity for gaming establishments.

These and other advantages may be realized by reference to the remaining portions of the specification, claims, and abstract.

### BRIEF DESCRIPTION OF ONE EMBODIMENT OF THE PRESENT INVENTION

One embodiment of the present invention may comprise at least one primary game, the primary game comprising of at least one set of playing symbols, at least one set of a predetermined number of playing symbols select from the set of playing symbols; and at least one random symbol generator, which is used to select the set of a predetermined number of playing symbols from the set of playing symbols; at least one tournament game, the tournament game comprising one set of tournament values with each tournament value being assigned to each playing symbol of the set of playing symbols, at least one player interface device configured to display a plurality of playing symbols, and at least one ranked tournament game prize; wherein the ranked tournament prize is awarded if the tournament game player has the player interface device whose plurality of playing symbols contains one or more playing symbols from the set of predetermined number of playing symbols, and if the sum of the predetermined tournament values associated with one or more playing symbols gives the tournament game player same rank as the ranked tournament prize.

Another version of this embodiment could be a method of playing a tournament game, comprising, but not all necessarily in the order shown; playing a primary game with the set of playing symbols; selecting a set of tournament values; matching a set of set of tournament values with a set of playing symbols; ranking a set of tournament prizes; selecting a set of predetermined number of playing symbols from a set of playing symbols; determining if the secondary player interface device has a possible winning combination of playing symbols; summing the tournament values of the possible winning combination of playing symbols of secondary player interface card; ranking the player assigned to secondary player interface card in comparison to other potential tournament winners by the total value of the tournament values of the possible winning combination of playing symbols of secondary player interface card; awarding the player at least one ranked tournament game prize if his ranking matches the ranking given to the tournament game prize.

Another version of this embodiment could be a game tournament comprising of at least one primary gaming means for playing a game; a symbol means for identifying winner in the primary game; a random symbol generator means for selecting a set of a predetermined number of symbol means from the symbol means; a tournament values means for ranking of more than one game tournament player; a tournament player interface means for display of a plurality of playing symbols means; and a ranked tournament prize means for rewarding a winning player; wherein the ranked tournament prize means is awarded to the tournament game player holding the player interface means, if a portion of the plurality of the playing symbols means matches at least a portion of selected set of playing means and if the ranking of the tournament game player matches the rank of the tournament game prize means.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic showing one embodiment of the relationship between the primary game and the secondary game

FIG. 2 is substantially a frontal view of one embodiment of a player interface device of the present invention.

FIG. 2A is substantially a frontal view of one embodiment of a player interface device of the present invention.

FIG. 3 is substantially a frontal view of one embodiment of a player interface device of the present invention.

FIG. 4 is substantially a view of one embodiment of a table showing the results from a random selection of a predetermined number of player symbols from the present invention.

FIG. 5 is substantially a view of one embodiment of a table of the present invention showing a selection of tournament values.

FIG. 6 is substantially a view of one embodiment of a table of the present invention showing the ranking of tournament game prizes.

FIG. 7 is substantially a view of one embodiment of a table of the present invention showing a tournament ranking and standings.

FIG. 8A is substantially a view of a flow chart showing one embodiment for a process of operating the invention.

FIG. 8B is a continuation of the flow chart of FIG. 8A.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

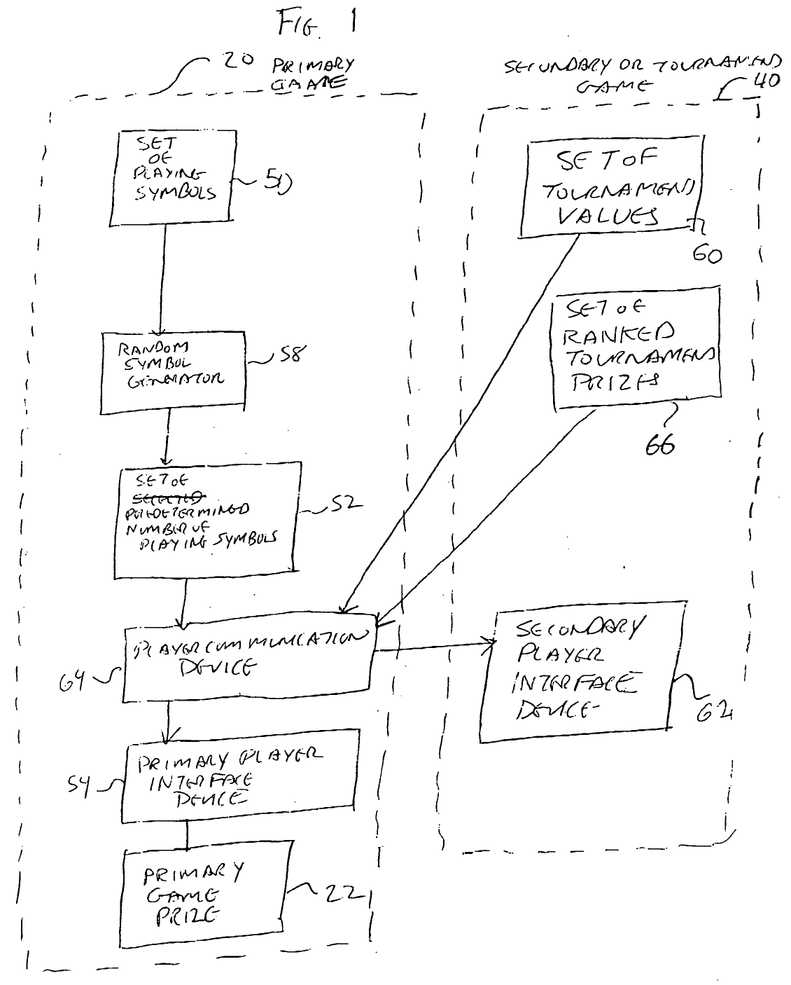

As essentially shown in FIG. 1, the present invention could comprise of at least one primary game, generally indicated by reference number 20, and at least one secondary or tournament game, generally indicated by reference number 40.

In at least one embodiment, the primary game 20 could be a lotto-type game such as Keno, Bingo, Lotto or the like. It is also envisioned that the invention, in at least one embodiment, could utilize non-lotto type games for the primary game 20.

The primary game 20 could be comprised of at least one set of playing symbols 50 (the number and type could be predetermined by the operator for a particular application of the invention); a random symbol generator 58 (or a pseudo-random symbol generator or any other such appropriate means to select a set of predetermined number of playing symbols 52 from the set of playing symbols 50 during play); a player communication device 64 (for relaying gaming information to players); at least one primary player interface device 54 (e.g., a bingo card or electronic version of the bingo card); and at least one primary game prize 22.

The primary player interface device 54 could be in the traditional printed format of a Keno card, a Bingo card and the like, or it could present an electronic version of the printed format. The electronic version in at least one embodiment could possibly allow the primary game player to connect to an electronic system or apparatus, which has the capability of accessing at least one electronic communications network, such as one operated by and interfacing with the operator of the invention. Additionally, the electronic communications network could also be one that connects multiple computer networks and multiple organizational computer facilities around the world (e.g., the Internet).

The primary player interface device 54 may generally display either a plurality of playing symbols 50 (e.g. Bingo) or the entire set of playing symbols 50 (e.g., Keno). In the embodiment utilizing the game of Keno as the primary game 20, the player generally selects playing symbols 50 upon which the player wishes to wager from the full set of playing symbols 50. The operator of the game (e.g., gaming establishment) may then randomly (or pseudo-randomly) select (e.g., using a random symbol generator) a set of predetermined number of playing symbols 54 from the set of playing symbols 50. If Keno player has chosen one or more playing symbols 50 on the primary player interface device 54, which then match the playing symbols 50 randomly selected by the operator, the player may win a primary game prize 22.

In the embodiment utilizing traditional style Bingo as the primary game 20, the player is essentially is limited to playing with a plurality of playing symbols 50 displayed on the primary player interface card 54, not the entire set of playing symbols 50. After the operator of the game randomly (pseudo-randomly) selects a set of predetermined number of playing symbols 52 from the full set of playing symbols 50, the primary player interface device 54 is then checked to see if any playing symbols 50 from the set of predetermined number of playing symbols 54 are displayed (e.g., in a grid). If there is such a match up of playing symbols 50, it is then determined if the matched up playing symbols on the grid fall within a certain pattern or predetermined geometric orientation on the grid. Such a geometric orientation could be a row, a column, a diagonal; the four corners of the grid. Other geometric orientations could be grid patterns formed with letters such “X”, “U”, “L”, “H”, or “T”. Still other geometric orientations could have matched up playing symbols 50 located on those spaces immediately adjacent to and surrounding a “free” space or covering all the spaces in the grid. When the matched up playing symbols form at least one of the proper geometric orientations, the player may win a prize in that primary game 20.

The winning of primary game prizes 22 in the primary game(s) 20 is generally separate from the winning of tournament games prizes 68 in the secondary or tournament game(s) 40.

The secondary game 40 could comprise of at least one set of tournament values 60 (each value being assigned to at least one playing symbol 50); at least one set of tournament game prizes 66 that are ranked; and at least one secondary player interface device 62 (which is assigned to at least one player participating in the second or tournament game 40).

In the primary game 20, the operator-selected set of playing symbols 50 is programmed into or otherwise applied to the random symbol generator 58 (or pseudo-random symbol generator, etc.). The random generator 58 then randomly (or pseudo-randomly depending on the embodiment) selects a set of a predetermined number of playing symbols 52. The predetermined number of playing symbols 52 is then communicated to the player communication device 64 where the gaming information is transmitted to one or more players. In at least one embodiment, the player assigned to a primary player interface device 54 then checks to see if any of the playing symbols 50 for the set of predetermined number of playing symbols 52 matches with any playing symbols 50 displayed on the primary player interface device 54 in the proper combination, number, orientation or like to denote a winner pursuant to the rules of the primary game 20. If there is a winning match up, the player in the primary game 20 could win a primary game prize 22.

In the secondary game or tournament game 40, which could played alongside the primary game 20, tournament values 60 from the set of tournament values 60 are paired with the playing symbols 50 from the set of playing symbols 50. This data on this pairing, along with any other relevant secondary gaming data (e.g. the tournament game prizes 66 and their rankings, etc.) are then transmitted to the player communication device 64. The player communication device 64 can relay the gaming data and any other relevant data to one or more players of the secondary or tournament game 40 (or in the electronic formats of the invention, to electronic versions of the secondary player interface devices 62). In this manner, the selection of predetermined number of playing symbols 50) is compared the playing symbols 50 that displayed by or otherwise associated with the secondary player identification devices 62.

After completing this comparison, the tournament game player could be a tournament winner and receive a ranked tournament game prize 66 if 1) there was a one or more match ups between the set of predetermined number of playing symbols 50 and those playing symbols 50 are displayed by the tournament game player's secondary player interface device 62; and 2) if sum of the tournament values 60 of the matched up playing symbols essentially gave a ranking to the player (e.g., ranking him among other players who had matched up playing symbols) that generally matched the ranking of the tournament game prize 66.

Depending on the particular embodiment, the playing symbols 50 could be a set of any characters selected by the operator. For those embodiments whose primary games 20 may be the more standard forms of lotto-type games, the playing symbols 50 tend to be numbers, letters or both. For example, one version of Bingo could have the letter “B” associated numbers 1-15, the letter I associated with numbers 16-30, the letter N associated with numbers 31-45; the letter G associated with the numbers 46-60; and the letter O associated with the numbers 61-75 (e.g. one Bingo ball could be marked “0-62”). Another example could be Keno, wherein the set of playing symbols 50 is essentially the set of numbers of 1 through 80. The invention is not limited to using numerals and letters for the set of playing symbols 50 and may use other indicia in addition to or instead of numerals and letters depending on the particular needs of the invention in any one application.

As stated earlier in the application, the random symbol generator 58, includes any means which has the ability to randomly select (or in certain embodiments the ability to pseudo-randomly select) a set of predetermined number of playing symbols 52. One such random symbol generator 58 (not shown), is a small spherical cage containing several balls each marked with a different numeral. The cage has a catch that will randomly select one ball, hence one playing symbol, when the cage is rotated. Another such random symbol generator 58 (not shown) is a blower wherein a set of hollow balls, each bearing a different playing symbol, is held in a large clear container. The blower uses air pressure within the container to blow around the balls to select one ball (and hence one playing symbol) at a time in a catch located on the container.

The secondary or tournament game 40 would be further comprised of a theme, which the operator of the invention selects. This theme could influence the selection of the set of tournament values 60, the design of the secondary player interface device 62, and the awarding of the tournament game prize(s) 65. The tournament theme could be selected from a wide variety of themes such as golf, tennis, bowling, poker, music, movies, antiques, sunken treasures, fishing and the like. For example, if the theme of the tournament game was a fishing tournament, then the set of tournament values 60 would be fish weight in pounds (e.g., the number 14 as a playing symbol could be given a tournament value of 230 pounds). Accordingly, the secondary player interface device 62 could be designed to be reflective of a fishing tournament (e.g., display fish and fish-related designs and indicia).

In at least one embodiment, the set of tournament values 60, as selected by the operator of the invention, could be different from the ordinary values normally assigned to the set of playing symbols 50, (e.g., the number 14 as a playing symbol could be given the tournament value of 200). Additionally, the set of tournament values 60 could further use denominations (e.g., currency, weight, external measurements). For example, a playing symbol, such as the number 14, could have a tournament value of 200 dollars or 200 pounds or 200 inches or 200 gallons and so on. In at least one embodiment, the set of tournament values 60 are only denomination-based so that playing symbol as number 14 could have a tournament value of 14 pounds or 14 inches or 14 gallons or 14 dollars and so on.

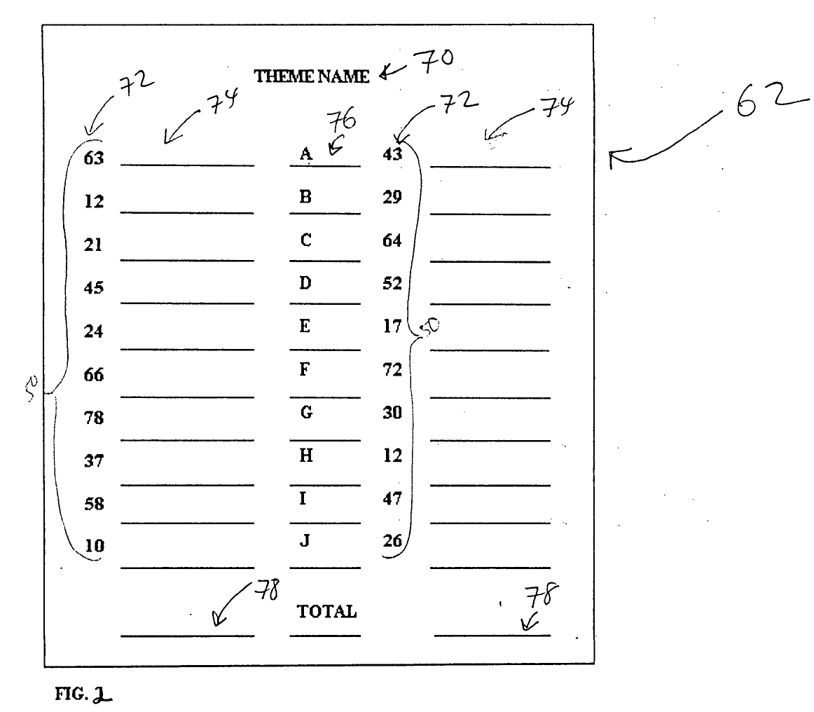

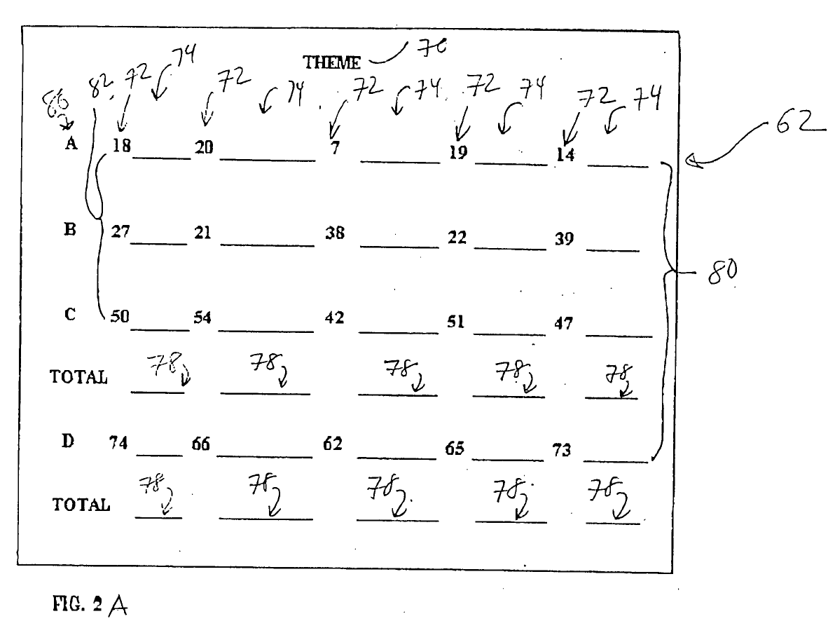

As essentially shown in FIG. 2, the secondary player interface device 62, as with the primary player interface device 54 (see FIG. 1), could be printed matter, such as a traditional card, bearing the appropriate indicia or it could be an electronic format. In the electronic format version, the secondary player interface device 62 could allow the player to connect to electronic system or apparatus which has the capability of accessing at least one electronic communications network, such as one operated by and interfacing with the operator of the invention. Additionally, the electronic communications network could also be one that connects multiple computer networks and multiple organizational computer facilities around the world (e.g., the Internet). It is further envisioned that in at least one embodiment, the primary player interface device 54 in its electronic format, could also function as the secondary player interface device 62 or have the qualities of the secondary player interface device 62, in that the primary player interface device 54 could display the data that would be normally hosted by the secondary player interface device 62 as well as handle any communication of data normally accomplished by the primary player interface device 54 as well.

In the accordance with the selected theme for the tournament, the secondary player interface device 62 could similarly bear a design and indicia from a wide variety of formats. Specific examples of the card version of the secondary player interface device 62 will be generally described below in more detail.

In at least one embodiment where card versions of the secondary player interface device 62 are being used, the player communication device(s) 64 (see FIG. 1) could be large electronic display screens as known in the art. The operator could use these player communication devices 64 to communicate to the player(s) of the invention several types of information such as the set of the predetermined number of playing symbols 54, set of tournaments values 60, and rank tournament game prize data. Other possible information, which could be communicated by the player communication device 64, may include tournament game winner identification, future events, and tournament information and other data. In the electronic format of the player interface devices, the above-information could be communicated to the player(s) via the primary player interface device 54, secondary player interface device 62, as well as through or instead of, the player communication device 64.

More than one tournament game prize 66 would be issued in the invention. As indicated above, this tournament game prize 66 would be separate and apart from any primary game prizes 22 awarded in the primary game 20. Each tournament game prize 66 would also be assigned a rank in relation to any other tournament game prizes 66 that are also awarded in that particular tournament.

At least one tournament game prize 66 could be won when one or more of playing symbols 50 from the set of a predetermined number of playing symbols 52 matches a predetermined number of the playing symbols that are normally displayed on a secondary player interface device 62. This matching or match up of playing symbols 50 could be used initially to identify or indicate that the tournament player holding (e.g., assigned to) the secondary player interface device 62 could be a potential winner for a ranked tournament game prize 66.

To fully determined if the potential tournament prizewinner is an actual tournament game prizewinner, the tournament values 60 assigned to the matching playing symbols 50 may be then added together. This tournament value 60 sum may then used to rank the potential tournament prizewinner against other potential tournament prizewinners.

In one embodiment, the potential tournament prizewinner who has essentially has the same ranking as a ranked tournament prize 66 may receive that ranked tournament game prize 66. This ranking could be based on numerical superiority (e.g., numerically the highest or possibly the lowest) to other potential winner players in the tournament, then that particular potential winning player wins the tournament game prize 66.

In operation of at least one embodiment of the invention, the operator essentially sets up the primary game(s) 20 and secondary game(s) 40 (see FIG. 1). The primary game 20 may then be started and run according the well-known rules and formats (e.g. setting up issuing primary player interface devices to players of the primary game, selecting a set of a predetermined number of playing symbols 52, establishes player communication device(s) 64, etc,). The operator could, in at least one embodiment, simultaneously set up the secondary or tournament game 40 (e.g., selects theme, selects set of tournament values 60 for the playing symbols, selects and ranks the tournament game prizes 66, issues secondary player interface devices 62 to paying secondary or tournament game players, and the like.) The players of the tournament game 40 could include primary game 20 players or non-primary game players.

In setting up the secondary game 40, if the operator selects, for example, the fishing tournament theme, then the secondary player interface device 62 is designed accordingly to have fish motifs, indicia and like. Accordingly, when the operator selects or causes the selection of set of the tournament values 60, these values will be numerical and have weight denominations (e.g. player symbol 26 will be assigned tournament values of 125 pounds, etc) reflecting the chosen tournament theme.

Additionally, the selection and assignment of the tournament values 60 can be further controlled using methods known in the art so that percentage of the range of tournament value 60 can be assigned to certain ranges of player symbols. For example, in at least one embodiment of the tournament game 40 having a fishing motif, the 100-200 pound tournament value range could be assigned to 5% of the playing symbol set 50; 201-300 pound tournament value range is assigned to 70% of the playing symbol set 50; 301-400 pound tournament value range is assigned to 20% of the playing symbol set 50; and 401-500 pound tournament value range is assigned to 5% of the playing symbol set 50.

As essentially shown in FIG. 2, one version of the secondary player interface device 62 may comprise of a theme display 70, two columns of playing symbols 72, which are essentially on either side of the secondary player interface device 62. Each of the two columns of playing symbols 72 may represent two chances for the player holding that secondary player interface device 62 to win a tournament game prize 66. Generally adjacent to each playing symbol column 72 is a tournament value column 74 bearing entry spaces to fill in the tournament values 60 assigned to the respective playing symbol 50 listed in the playing symbols columns 72. In between these two series of columns is a theme icon column 76 having of spaces (e.g., A-J) for the placement of the theme icons that are determined by the respective playing symbols 50, tournament values 60 or both. For example, space A could have a theme icon, which could be a depiction of a marlin based on the playing symbols 50, the numbers 63 and 43, which are in the playing symbols columns 72. At the bottom of tournament value columns 74 are summation spaces 78 wherein the sums of tournament values 60 listed in the tournament value columns 74 are placed.

A wide variety of security measures and devices known to the art or, which will become known in the art can be employed to prevent abuse of the invention by the tournament players. For the card versions of the player interface devices, serial numbers and bar codes could be employed along with duplicate copies of issued player interface devices to be held by the operator to verify actual winning player interface devices. For electronic-format based player interface devices, electronic security and anti-tampering measures such as firewalls could be employed.

When at least one playing symbol column 72 for a secondary player interface device 62 contains the necessary number of playing symbols 50 from the set of predetermined number of playing symbols 52, this indicates that the player holding that particular secondary player interface device 62 is a potential tournament game prize winner (e.g. potential winning tournament player).

The potential tournament winning player could then be given a rank based on the tournament values 50 associated with the “matched up” playing symbols in the winning playing symbols column (e.g. the playing symbols 50 contained in the “winning” playing symbol column 72) or the sum of all the tournament values 50 which are displayed on the secondary player interface device 62. As stated above, if the potential winning tournament player's ranking among other potential winning tournament players essentially matches the ranking of a tournament game prize 66, then that particular potential winning tournament player may get that particular tournament game prize 66. The tournament game prize 66 can, in at least one embodiment, be comprised of monies taken from the funds collected from player's payments for the assignment of player interface devices (minus a take for the operator for running the tournament).

After the operator communicates winning tournament player identification information via the player communication device(s) 62, the winning tournament player(s) may receive the respective tournament game prize(s) 66.

Another possible embodiment of the secondary player interface device 62 can be essentially seen in FIG. 2A, wherein the secondary player interface device 62 provides for several possibilities of winning a 4 spot 80 (or a 3 spot 82 if no 4 spot 80 winning combination occurred in the tournament). A 4 spot 80 generally means that the four playing symbols of one playing symbol column 72 should match up with playing symbols 50 from the set of a predetermined number of playing symbols 52. If there are no 4 spot winners, then a 3 spot may be used to essentially match up the three (3) playing symbols listed in playing symbol column 72 with the playing symbols 50 from the set of a predetermined number of playing symbols 52.

The format of the secondary player interface device 62, as essentially shown in FIG. 2A, therefore generally comprises, in the manner described-above for the secondary player interface device generally shown in FIG. 2, of a theme display 70, five columns of playing symbols 72. Each playing symbol column 72 may represent two chances of winning a tournament game prize 66. Each playing symbol column 72 could have a 3 spot 82 and 4 spot 80, with respective spaces for the summation of the two spots 84.

A column of theme icons 86 (represented by A, B, C, and D) can be located on one side of the secondary player interface device 62. For example, A could be a theme icon which could be a depiction of a marlin based on the player symbols, the numbers 18, 20, 7, 19, 14, in playing symbol columns 72. Adjacent to each playing symbol column 72 may be a tournament value column 74 bearing spaces for the general insertion of the tournament values assigned to each playing symbol in the playing symbol column 72.

For the operation of this version of the secondary player interface device 62, when a tournament player essentially holds a secondary player interface device 62 with a matching a four spot 80 (or a matching 3 spot 82 if no matching 4 spot 80 is generated in the tournament), the summation of the matching spot's tournament values may give ranking to the tournament player. If rank of the tournament player correspondingly matches the rank assigned to a tournament game prize 66 given for a winning spot, the tournament player then may receive that tournament game prize 66.

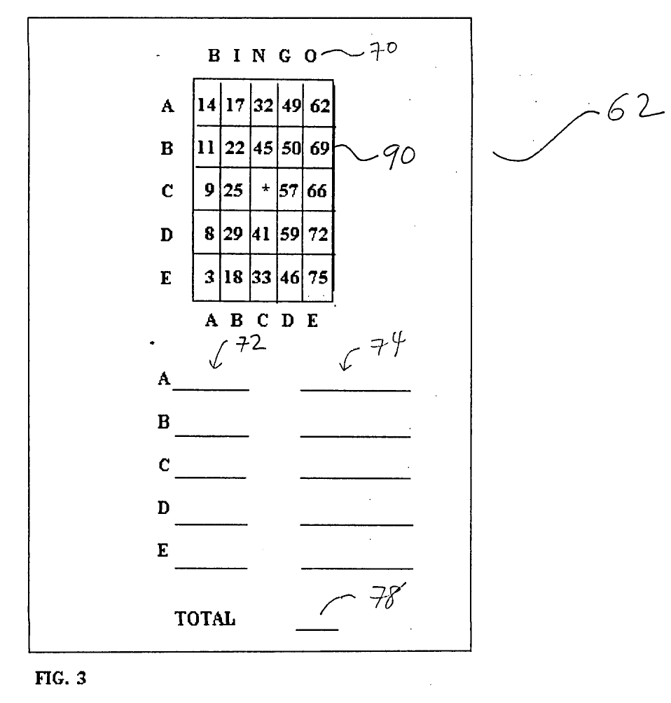

One possible version of secondary player interface device 62 as used in a secondary game that may utilize a Bingo type format is essentially shown in FIG. 3. Here, the secondary player interface device 62 may further features a “Bingo” grid 90 comprised essentially of five columns and five rows whose squares may each contain a playing symbol which can include the playing symbol “*” representing “Ø” or null. Assigned to each row and column may be a theme icon (represented here by the letters A, B, C, D, & E). The theme icons assigned to the rows may be same theme icons assigned to the columns.

Below the grid 90, there may be two columns of spaces, one playing symbol column 72 for entering the matched up playing symbol and one tournament value column 74 for essentially entering the tournament value assigned to the matched up playing symbol. Assigned to each space in each column may be a theme icon. At the bottom of the tournament values column 74 is generally a summation space 78 where the summed value of the tournament values column 74 may be placed.

As the primary game 20 is generally operated and the set of a predetermined number of playing symbols 52 is essentially randomly selected, the tournament player generally holding the “Bingo” secondary player interface device 62 essentially becomes a potential tournament winner if the playing symbols in a column, row, diagonal, or the like of the grid 90 generally matches up with playing symbols 50 from the set of a predetermined number of paying symbols 52. When such a match up essentially occurs, the tournament player generally takes the secondary player interface device 62 or otherwise generally communicates the playing data displayed on the secondary player interface device 62 to the operator. In the card version of the “Bingo” secondary player interface device 62, the operator essentially verifies the “BINGO” match up on the grid 90 and then generally locates the matched up playing symbols in the grid 90 in the playing symbol column 72 below the grid 90. The matched up playing symbol(s) 50 is generally placed in the space of the playing symbols column 72, which is assigned to the same theme icon that is assigned to the row, column where the matched playing symbol may be found in the grid 90. The assigned tournament values 60 generally assigned to the matched up playing symbols 50 are then essentially entered in the tournament values column 74 and essentially summed up in the summation space 78. Then as generally stated-above for other embodiments, the sum of the tournament values 60 then essentially determines the potentially winning tournament player's ranking in relation to the other potentially winning tournament players. If the potentially winning tournament player's rank generally matches the rank of a tournament game prize 66, then the potentially winning tournament player becomes an actual winning tournament player to essentially that tournament game prize 66.

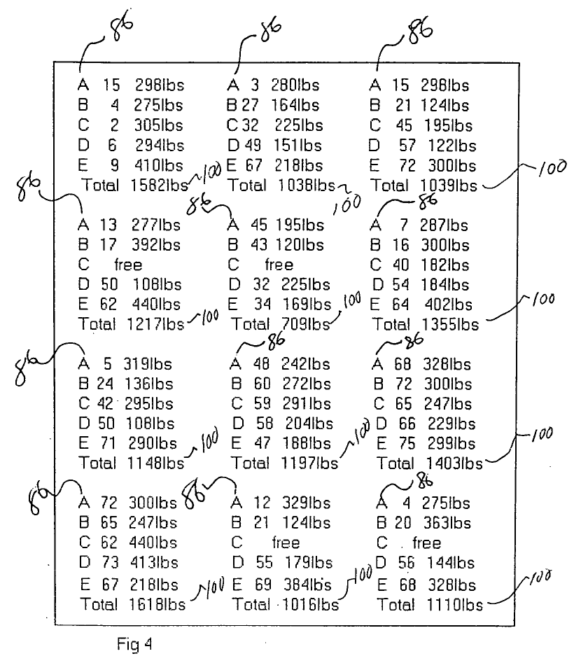

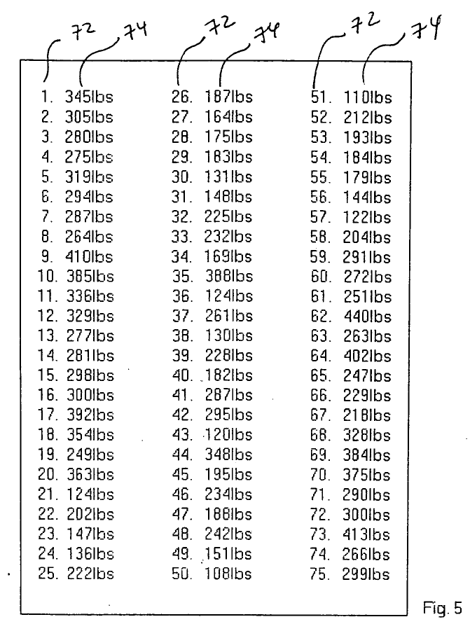

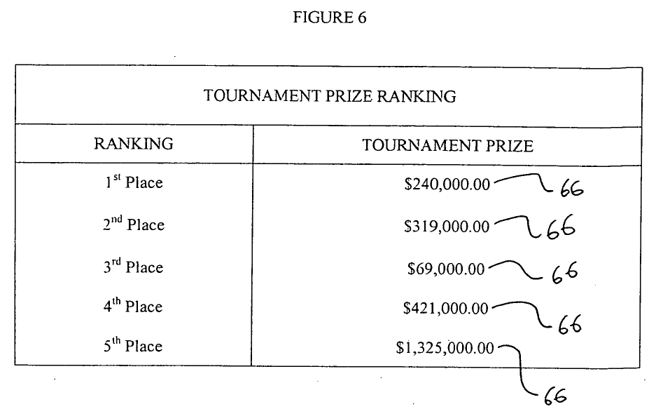

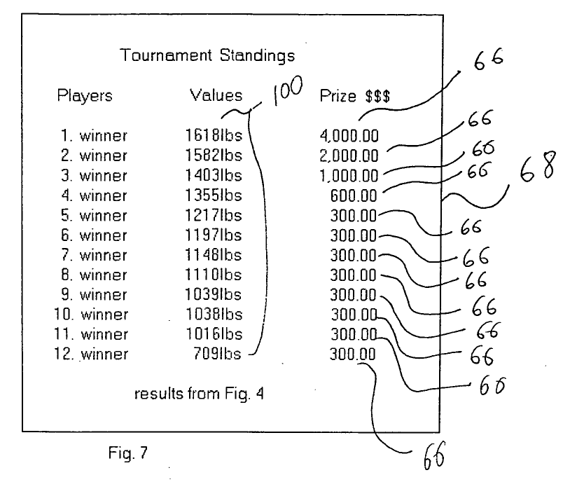

FIGS. 4, 5, 6, and 7 essentially show the types of information that could be communicated by the secondary player communication device 62. FIG. 4 shows the results of the randomly selected set of a predetermined number of playing symbols 52, wherein the partial information (e.g., theme symbols 86, assigned playing symbols 50, and the like) selected from one or more potentially winning secondary player interface devices 62. FIG. 5 shows the assignment or pairing of tournament values 60 to the set of playing symbols 50. FIG. 6 shows the ranking of the tournament game prizes 66 for a particular secondary or tournament game 40. FIG. 7 is the tournament standings display showing the identities of the various winners, their corresponding total tournament values 100, and the ranked prizes, which the various winners won according to their total tournament values 100.

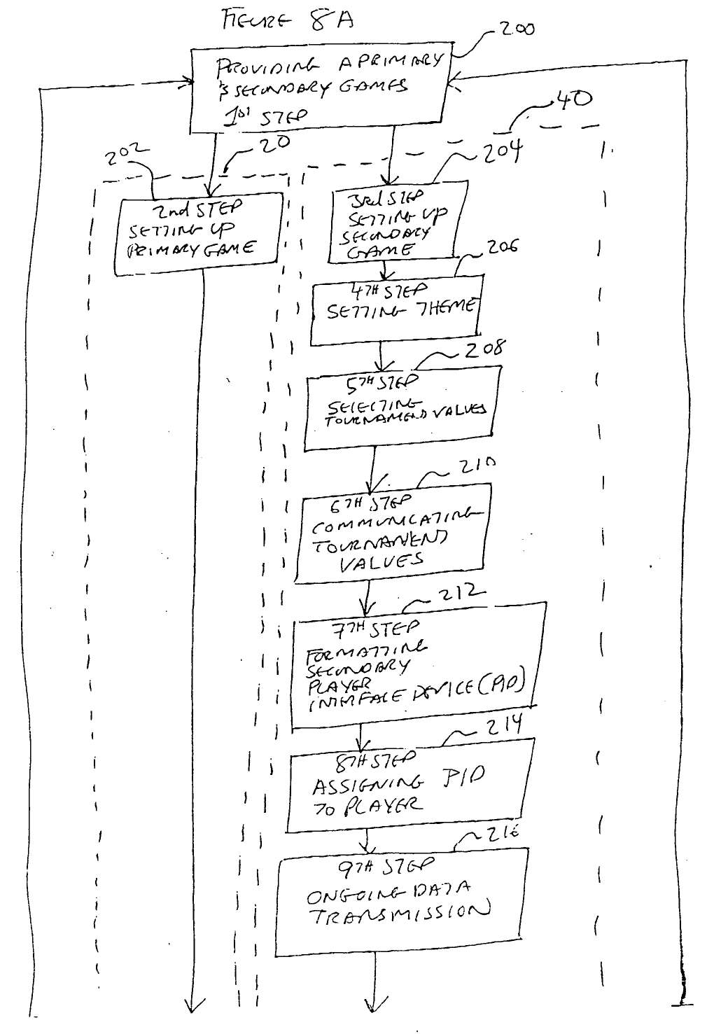

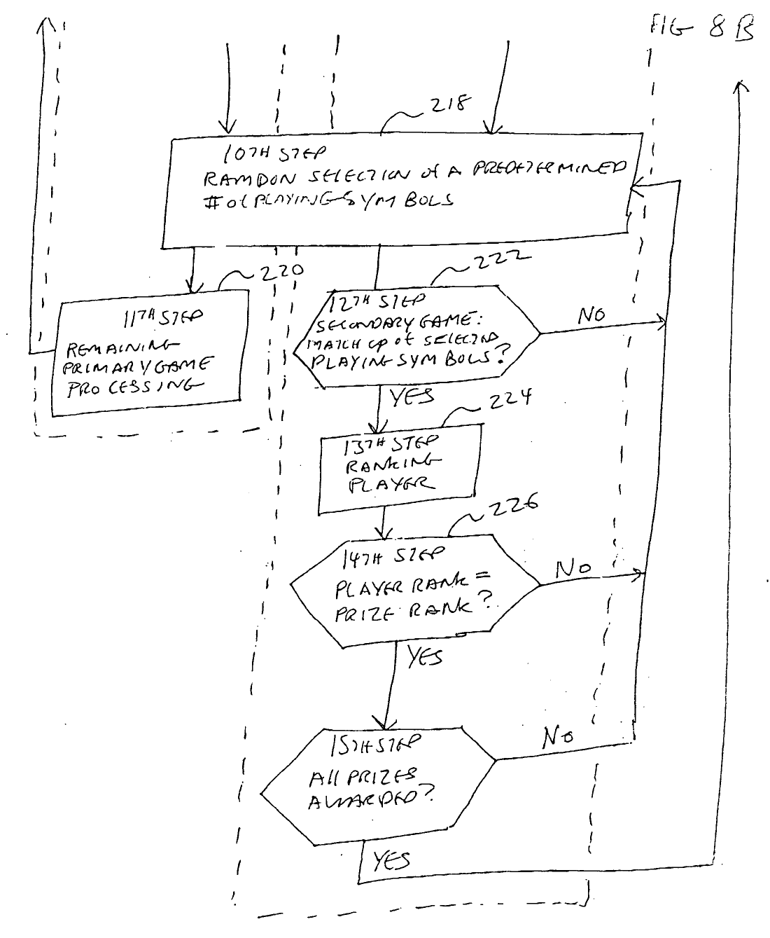

FIG. 8 essentially shows a flow chart generally demonstrating one possible method of operation for the invention. This method of operation could be incorporated into or incorporate a part of at least one software program utilizing at least one central processing unit or system. The first step 200 could be the providing of a primary game 20 and secondary game 40. The primary game 20 could be either a lotto-type game or other type of game. Provided with this primary game 20 would be a set of playing symbols 50 as well as one ability to randomly select a predetermined number of playing symbols from one set of playing symbols. This primary game 20 could further include a primary player interface device 54 and at least one primary game prize 22. First step 200 could then proceed to second step 202 would be setting up the primary game 20 (e.g., selecting set of playing symbols 50, selecting an ability to randomly select a predetermined number of the set of playing symbols 50, formatting the primary player interface device 54, assigning primary player interface device 54 to paying and playing primary game players, collecting payment from the assignment of the primary player interface device into prize cache, detecting operator take from the prize cache, etc.).

The first step 200 could also proceed to a third step 204, which could be the providing a secondary or tournament game 40 that could run in conjunction with and concurrently with the primary game 20. The tournament game 40 could have the ability to accept wagers from tournament players participating in the invention.

The third step 204 could proceed to a fourth step 206, which could be the selection of a theme for the tournament game 40.

The fourth step 206 could proceed to a fifth step 208, which could be the selecting and providing at least one set of tournament values 60 based on the tournament theme. In this fifth step 208, at least one tournament value could be assigned to each playing symbol 50. Further, in at least one embodiment, at least one tournament value 50 could be Ø or null.

The fifth step 208 could lead to a sixth step 210, which could be the communication to the tournament player(s) of the selected tournament values 60 as they are assigned to the playing symbols 50.

The sixth step 210 could lead to a seventh step 212, which could be the formatting of the secondary player interface device 62. This formatting could include the one or more of the following selections for incorporation into the display of the secondary player interface device 62: the selected playing symbols 50 for the particular player interface device, the design format (e.g., selection of a grid 90); the selected theme for the tournament game 40; the corresponding theme icons and the like. In the card version of the secondary player interface device 62, this step 212 could also include the printing up of the card version of the secondary player interface device 62. In the electronic version of the secondary player interface device 62, this could include transmitting/establishing the correct data in the secondary player interface device 62 to proved the correct and wanted display of information and data.

The seventh step 212 could lead to an eighth step 214, which could be the assigning, distributing or otherwise disbursing the formatted secondary player interface device 62 to secondary or tournament players. As noted above, this group of players could include primary game players. In at least one embodiment, the secondary or tournament game player pays the operator for the right to be assigned at least one secondary player interface device 62. The financial income from this revenue stream can be used to provide the capital for securing or otherwise providing the tournament game prize(s) 66 (e.g. purse) for the tournament game(s). The financial income could also provide for the operator's profits and operating costs.

The eighth step 214 could lead to a ninth step 216, which could be the establishment and ranking of one or more tournament game prizes 66. As stated above, the establishment of the tournament game prizes 66 could be based on the above-mentioned financial income or other capital source.

The eighth step 214 could lead to the ninth step 216, which could be the ongoing transmission of various gaming and other data to the tournament player(s). In at least one embodiment, the transmission is accomplished with player communication device(s) 64 (e.g., large picture screens, etc.). In at least one embodiment, the transmission of data could include, but not be limited to the ranking of tournament game prizes 66 for a particular secondary or tournament game 40; the identification of the tournament game winners, their corresponding total tournament values, the listing of ranked tournament game prizes the winners won based on their total tournament values, and the like.

The ninth step 216 and third step 204 could lead to a tenth step 218, which is the random (or pseudo-random) selection of set of a predetermined number of playing symbols 52 from the set of playing symbols 50. In at least one embodiment (not shown) the random selection could be done one playing symbol 50 at a time, with information for each randomly selected playing symbol 50 being transmitted to at least one tournament player at or after the time of selection. In at least one embodiment, the random selection of the set of predetermined number of playing symbols 52 from the selected set of playing symbols 50 could be done at the same time, with the transmission of the data about such selection released to the tournament players based on one selected symbol at a time. In at least one embodiment, the random selection of the set of a predetermined number of playing symbols 52 from the selected set of playing symbols 50 could be done at the same time, with the transmission of the data about all the selected playing symbols 50 being released to the tournament players all at once.

For the primary game 20, the tenth step 218 could lead to an eleventh step 220 which is the remaining processing and running of the primary game 20, which could include such steps as establishing one or more winners of the primary games, establishing which winner gets what prize, and the like. The eleventh step 220 for the primary game can then cycle back to the first step 200.

For the secondary or tournament game 40, the tenth step 218 could lead to twelfth step 222, which is the decision: “Is there a match up of certain number of playing symbols 50 displayed on a secondary player interface device 62 with the set of a predetermined number of paying symbols 52?” If the answer is no, the twelfth step 222 proceeds back to tenth step 218. If the answer is yes, the player holding the secondary player interface device 62 may be a potential winner in the tournament and the process proceeds to the thirteenth step 224.

The thirteenth step 224 is the summation of the tournament values of the matched up playing symbols displayed on the secondary player interface device 62 to establish the ranking of the potential winning tournament player with other potential tournament winning players. In at least one embodiment, the tournament value summation is for all playing symbols 50 shown on the secondary player interface device 62. The thirteenth step 224 leads to the fourteenth step 226.

The fourteenth step 226 is the decision: “does the ranking of the potentially winning tournament player match a ranking of a tournament prize?” If the answer is yes, then the tournament player gets the prize and the fourteenth step 226 proceeds to the fifteenth step 228. If the answer is no, the fourteenth step 226 proceeds to the tenth step 218.

The fifteenth step 228 is the decision: “have all the tournament game prizes been awarded?”. If the answer is no, the fifteenth step 228 proceeds back to the tenth step 218. If the answer is yes, the tournament is over and the process cycles back to the first step 200 for the establishment of at least one new secondary or tournament game 40 if so desired by the operator.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

1. A gaming tournament, comprising:
a) at least one primary game, the primary game comprising of at least one set of playing symbols, at least one set of a predetermined number of playing symbols selected from the set of playing symbols; and at least one random symbol generator, which is used to select the set of a predetermined number of playing symbols from the set of playing symbols;
b) at least one tournament game, the tournament game comprising one set of tournament values with each tournament value being assigned to each playing symbol of the set of playing symbols, at least one player interface device configured to display a plurality of playing symbols, and at least one ranked tournament game prize;
wherein the ranked tournament prize is awarded if the tournament game player has the player interface device whose plurality of playing symbols contains one or more playing symbols from the set of predetermined number of playing symbols, and if the sum of the predetermined tournament values associated with one or more playing symbols gives the tournament game player same rank as the ranked tournament prize.

2. The gaming tournament of claim 1 wherein the rank is based on lowest sums.

3. The gaming tournament of claim 1 wherein the rank is based on the highest sums.

4. The gaming tournament of claim 1 wherein the set of playing symbols have ordinary values outside the play of the first game, which are different from the set of tournament values.

5. The gaming tournament of claim 4 wherein the difference between the set of ordinary values and the set of tournament values is by amounts.

6. The gaming tournament of claim 5 wherein the difference is further defined by denominations.

7. The gaming tournament of claim 1 wherein the tournament game further comprises of a theme and the set of tournament values are given denominations, which reflect that theme.

8. The gaming tournament of claim 1 further comprises at least one overall tournament prize awarded during a set of tournament games, the overall tournament prize being ranked.

9. The gaming tournament of claim 1 wherein player interface device is an electronic apparatus.

10. The gaming tournament of claim 1 wherein the electronic apparatus has the capability of accessing at least one electronic communications network that connects multiple computer networks and multiple organizational computer facilities around the world.

11. The gaming tournament of claim 1 wherein the primary game is at least one game selected from a set of games consisting of: bingo, keno, lotto, and lottery.

12. The gaming tournament of claim 1 wherein the ranked tournament prize is awarded if the tournament game player has the player interface device whose plurality of playing symbols contains has one or more playing symbols from the set of predetermined number of playing symbols and one or more playing symbols are displayed in a predetermined geometric order on the player interface device.

13. The gaming tournament of claim 1 wherein one of the tournament values is null.

14. The gaming tournament of claim 1 wherein the tournament values are predetermined.

15. A method of playing a tournament game, comprising, but not all necessarily in the order shown:
(A). playing a primary game with the set of playing symbols;
(B). selecting a set of tournament values;
(C). matching a set of set of tournament values with a set of playing symbols;
(D). ranking a set of tournament prizes;
(E). selecting a set of predetermined number of playing symbols from a set of playing symbols;
(F). determining if the secondary player interface device has a possible winning combination of playing symbols;
(G). summing the tournament values of the possible winning combination of playing symbols of secondary player interface card;
(H). ranking the player assigned to secondary player interface card in comparison to other potential tournament winners by the total value of the tournament values of the possible winning combination of playing symbols of secondary player interface card;
(I). awarding the player at least one ranked tournament game prize if his ranking matches the ranking given to the tournament game prize.

16. A process of playing a game tournament of claim 15 is further comprised of selecting a theme for the tournament game, set of tournament values and tournament game prizes.

17. A process of playing a game tournament of claim 15 wherein the determining if the secondary player interface card has a possible winning combination of playing symbols includes having the one or more of the selected playing symbols forming a predetermined geometric orientation.

18. A process of playing a game tournament of claim 14 is further comprised of ranking the prize and awarding the prize to a tournament game winner based on that ranking.

19. A game tournament comprising of:
a) at least one primary gaming means for playing a game;
b) a symbol means for identifying winner in the primary game
c) a random symbol generator means for selecting a set of a predetermined number of symbol means from the symbol means;
d) a tournament values means for ranking of more than one game tournament player;
e) a tournament player interface means for display of a plurality of playing symbols means; and
f) a ranked tournament prize means for rewarding a winning player;
wherein the ranked tournament prize means is awarded to the tournament game player holding the player interface means, if a portion of the plurality of the playing symbols means matches at least a portion of selected set of playing means and if the ranking of the tournament game player matches the rank of the tournament game prize means.

20. The game tournament of claim 19 wherein the ranking of the tournament game player is based upon the sum of the tournament value means associated with the portion of set of selected playing means.

21. The game tournament of claim 19 wherein the tournament value means and ranked tournament game prize means share a common theme.

22. A game tournament of claim 20 further comprises a player communication device means for informing players of gaming data.
